(19) United States
(12) Patent Application Publication
(10) Pub. No.: US 2026/0273620 A1
(43) Pub. Date: Sep. 17, 2026

(54) POWDER FOR THERMAL SPRAYING

(71) Applicant: FUJIMI INCORPORATED, Kiyosu-shi, Aichi (JP)

(72) Inventors: Kohei SEKI, Kiyosu-shi, Aichi (JP); Takaya MASUDA, Kiyosu-shi, Aichi (JP); Naoki OKAMOTO, Kiyosu-shi, Aichi (JP)

(73) Assignee: FUJIMI INCORPORATED, Kiyosu-shi, Aichi (JP)

(21) Appl. No.: 19/168,407

(22) PCT Filed: Feb. 22, 2024
(86) PCT No.: PCT/JP2024/006465

§ 371 Date: Sep. 24, 2025

(30) Foreign Application Priority Data
Mar. 30, 2023 (JP) 2023-054593

(51) Int. Cl. B22F 1/148; B22F 1/00; C23C 4/11

(52) U.S. Cl. CPC B22F 1/148; B22F 1/09; C23C 4/11; B22F 2302/253; B22F 2304/10

(57) ABSTRACT

It is an object of the present invention to provide a novel powder for thermal spraying capable of improving performance of an yttrium-aluminum composite oxide coating film. A powder for thermal spraying, including a composite oxide formed with yttrium oxide and aluminum oxide, wherein the powder for thermal spraying is subjected to component analysis at any plurality (n) of positions of a scanning electron microscope image (SEM image) by an energy dispersive X-ray spectrometer (EDX) in which characteristic X-ray peak areas are measured, and a content of the element yttrium (C_{Y}(at %)) and a content of the element aluminum (C_{Al}(at %)) are calculated from a ratio of the peak areas and determined so as to satisfy the relationship of the following expression (1):

$${C}_{Y} + {C}_{Al} = 100 ( at \% ) , \qquad ( 1 )$$

and wherein a coefficient of variation (α) of an average content of the element yttrium [C_{Y}]ₐᵥ(at %) calculated by dividing a total value by n, the total value being obtained by adding a content of the element yttrium [C_{Y}] at each position represented by the following expression (2):

$${C}_{Y} / ( {C}_{Y} + {C}_{Al} ) ( at \% ) , \qquad ( 2 )$$

is 7.0% or less.

### TECHNICAL FIELD

The present invention relates to a powder for thermal spraying.

### BACKGROUND ART

Corrosion (including erosion) resistance is an indispensable quality for equipment components and liners used in a semiconductor processing chamber where a corrosive environment exists. Corrosive plasma is present in a large majority of environments for semiconductor processing including plasma enhanced chemical vapor deposition (PECVD) and physical vapor deposition (PVD), and the most corrosive plasma environments are that used for cleaning processing equipment and that used for etching a semiconductor substrate. These apply particularly to a case where high energy plasma is present and thereto is added chemical reactivity that acts on the surface of a component in the environment.

Here, yttrium oxide is a material that has proved to have high future potential in the protection of aluminum and aluminum alloy surfaces exposed to halogen-containing plasma as used for manufacturing a semiconductor device. It is said that by forming a thermally sprayed yttrium oxide coating film on the anodized surface of a high purity aluminum alloy-treated chamber surface or a processing component surface, excellent corrosion resistance is obtained (e.g., Patent Literature 1).

In addition, an yttrium-aluminum composite oxide is excellent in corrosion resistance and oxidation resistance, and thus it is more desirable as a material for a coating film onto a member made of a material that is inferior in the above resistances. For example, Patent Literature 2 discloses a technique of plasma spraying yttrium-aluminum composite oxide granulated-sintered particles to form an yttrium-aluminum composite oxide coating film.

### CITATION LIST

### Patent Literatures

Patent Literature 1: U.S. Pat. No. 6,776,873
Patent Literature 2: Japanese Patent Laid-Open No. 2002-80954

### SUMMARY OF INVENTION

### Technical Problem

However, during the course of studying an yttrium-aluminum composite oxide coating film, the present inventors have found that in the conventional technique, the intended performance of the yttrium-aluminum composite oxide coating film is not sufficiently exhibited.

Then, it is an object of the present invention to provide a novel powder for thermal spraying capable of improving performance of an yttrium-aluminum composite oxide coating film.

### Solution to Problem

In order to solve the above problem, the present inventors have earnestly studied. During the course thereof, they have focused on the presence of many heterogeneous phases in a conventional yttrium-aluminum composite oxide coating film. They have also focused on the fact that the presence of heterogeneous phases can be accompanied by heterogeneous presence of yttrium in the coating film.

During the course of further studies, they have found out that yttrium is present heterogeneously also in a powder for thermal spraying that is a raw material for forming the yttrium-aluminum composite oxide coating film. Then, they have found that by quantifying the heterogeneity in this powder for thermal spraying as a coefficient of variation of an average content of the element yttrium and by decreasing this value to a specific value or less, the coating film formed can be made more homogeneous.

Accordingly, one aspect of the present invention is a powder for thermal spraying, comprising a composite oxide formed with yttrium oxide and aluminum oxide, wherein the powder for thermal spraying is subjected to component analysis at any plurality (n) of positions of a scanning electron microscope image (SEM image) by an energy dispersive X-ray spectrometer (EDX) in which characteristic X-ray peak areas are measured, and a content of the element yttrium (C_{Y}(at %)) and a content of the element aluminum (C_{Al}(at %)) are calculated from a ratio of the peak areas and determined so as to satisfy the relationship of the following expression (1):

$$\begin{matrix}[ Expression 1 ] & \\ {C}_{Y} + {C}_{Al} = 100 ( at \% ) , & ( 1 )\end{matrix}$$

and wherein a coefficient of variation (α) of an average content of the element yttrium [C_{Y}]ₐᵥ(at %) calculated by dividing a total value by n, the total value being obtained by adding a content of the element yttrium [C_{Y}] at each position represented by the following expression (2):

$$\begin{matrix}[ Expression 2 ] & \\ {C}_{Y} / ( {C}_{Y} + {C}_{A 1} ) ( at \% ) , & ( 2 )\end{matrix}$$

is 7.0% or less.

### Effect of Invention

By using the powder for thermal spraying that is one aspect of the present invention, appearance of heterogenous phases in a composite oxide coating film formed with yttrium oxide and aluminum oxide can be significantly suppressed. This is consequently accompanied by the effects of improving external appearance of the coating film. In addition, the presence of yttrium in the coating film can be made more homogeneous. By at least one of these, a novel powder for thermal spraying capable of improving performance of a composite oxide coating film formed with yttrium oxide and aluminum oxide can be provided.

### BRIEF DESCRIPTION OF DRAWINGS

FIG. 1 is a view showing plots of Examples and Comparative Examples, in which a coefficient of variation of an average content (at %) of yttrium in a powder for thermal spraying (granules) is plotted on the X-axis and a coefficient of variation of an average content (at %) of yttrium in a coating film is plotted on the Y-axis.

FIG. 2 shows a 5000× magnification SEM image at an arbitrary position of a powder for thermal spraying of Example 6.

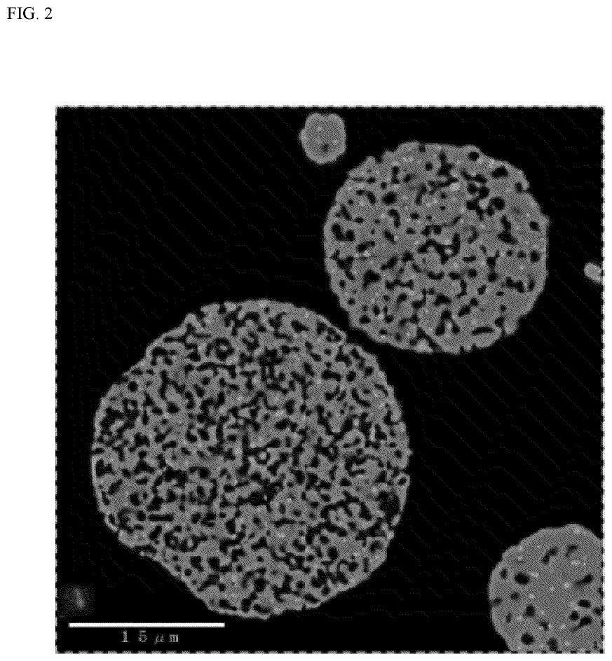

FIG. 3 shows a 5000× magnification SEM image at an arbitrary position of a powder for thermal spraying of Comparative Example 1.

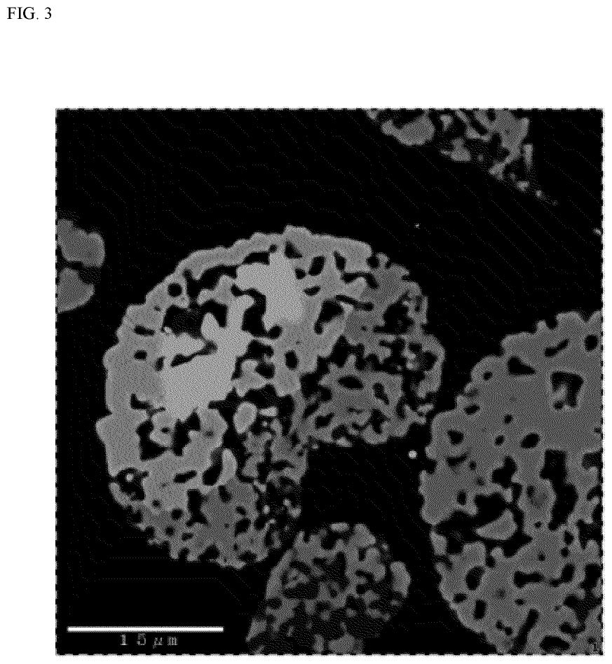

FIG. 4 shows a 15000× magnification SEM image at an arbitrary position of a coating film of Example 6.

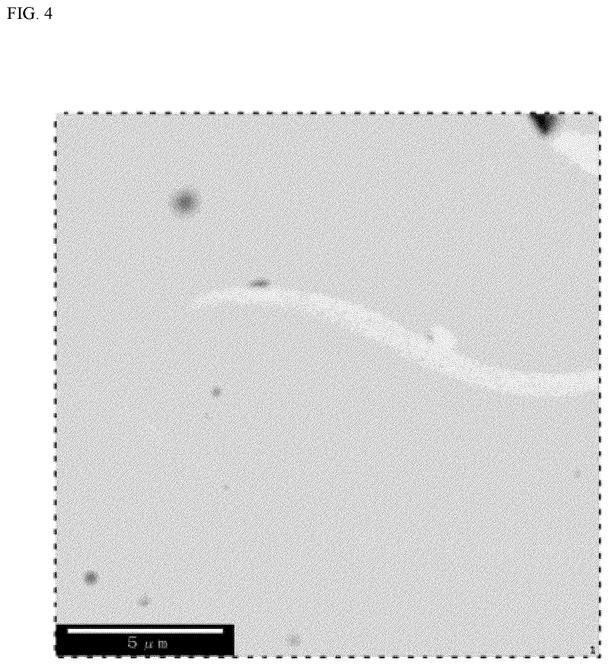

FIG. 5 shows a 15000× magnification SEM image at an arbitrary position of a coating film of Comparative Example 1.

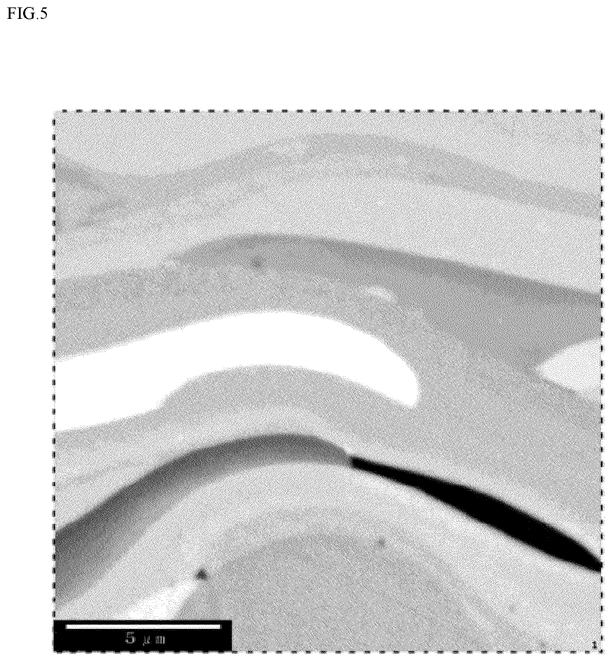

### DESCRIPTION OF EMBODIMENTS

Hereinafter, the present invention will be described in detail. In the present specification, “X to Y” is used to mean that the values described before and after that (X and Y) are included as the lower limit and the upper limit, and means “X or more and Y or less”. When a plurality of “X to Y” is described, for example, when “X1 to Y1, or X2 to Y2” is described, cases where each numerical value is the upper limit are disclosed, cases where each numerical value is the lower limit are disclosed, and combinations of these upper limits and lower limits are all disclosed (that is, this becomes legal basis for amendment). Specifically, amendment to X1 or more, amendment to Y2 or less, amendment to X1 or less, amendment to Y2 or more, amendment to X1 to X2, amendment to X1 to Y2, and the like must be all considered legal. When the features or the aspects of the present disclosure are described from the viewpoint of Markush Group, those skilled in the art will recognize by them that the present disclosure is described from the viewpoint of any individual component or a component subgroup of the Markush Group. Unless otherwise noted, operations and measurements of properties, etc. are carried out under the conditions of room temperature (20 to 25° C.)/relative humidity of 40 to 50% RH.

### <Powder for Thermal Spraying>

One aspect of the present invention is a powder for thermal spraying, including a composite oxide formed with yttrium oxide and aluminum oxide, wherein the powder for thermal spraying is subjected to component analysis at any plurality (n) of positions of a scanning electron microscope image (SEM image) by an energy dispersive X-ray spectrometer (EDX) in which characteristic X-ray peak areas are measured, and a content of the element yttrium (C_{Y}(at %)) and a content of the element aluminum (C_{Al}(at %)) are calculated from a ratio of the peak areas and determined so as to satisfy the relationship of the following expression (1):

$$\begin{matrix}[ Expression 3 ] & \\ {C}_{Y} + {C}_{A 1} = 100 ( at \% ) , & ( 1 )\end{matrix}$$

and wherein a coefficient of variation (α) of an average content of the element yttrium [C_{Y}]ₐᵥ(at %) calculated by dividing a total value by n, the total value being obtained by adding a content of the element yttrium [C_{Y}] at each position represented by the following expression (2):

$$\begin{matrix}[ Expression 4 ] & \\ {C}_{Y} / ( {C}_{Y} + {C}_{A 1} ) ( at \% ) , & ( 2 )\end{matrix}$$

is 7.0% or less. By using the powder for thermal spraying that is one aspect of the present invention, appearance of heterogenous phases in a composite oxide coating film formed with yttrium oxide and aluminum oxide can be significantly suppressed. In addition, the presence of yttrium in the coating film can be made more homogeneous. By significantly suppressing appearance of heterogeneous phases in the coating film, that is, by making the presence of yttrium in the coating film more homogeneous, the effects of improving performance of the whole film under a highly corrosive environment (e.g., under a reducing atmosphere) can be expected. This suppression of appearance of heterogeneous phases is accompanied by the effects of improving external appearance of the coating film. By at least one of these, a novel powder for thermal spraying capable of improving performance of a composite oxide coating film formed with yttrium oxide and aluminum oxide is provided. In the composite oxide formed with yttrium oxide and aluminum oxide, which is one aspect of the present invention, inclusion of oxides other than yttrium oxide and aluminum oxide is not restricted, but preferred is a composite oxide formed with only yttrium oxide and aluminum oxide, excluding inclusion of unavoidable components. In one embodiment of the present invention, the composite oxide preferably contains no metallic elements other than yttrium and aluminum. In one embodiment of the present invention, the coefficient of variation can be measured by using an energy dispersive X-ray spectrometer (EDX) attached to a scanning electron microscope (SEM).

In one aspect of the present invention, n represents the number of arbitrarily selected positions to obtain a scanning electron microscope image (SEM image), and the number can be 10 (n=10). Citing the present embodiment as an example, the values for the contents of the element yttrium [C_{Y}] at the 10 positions are all added, an average content of the element yttrium [C_{Y}]ₐᵥ(at %) calculated by dividing the value obtained thereby by 10 is obtained, and a coefficient of variation (α) indicating a degree of variation from the average content [C_{Y}]ₐᵥ(at %) is calculated.

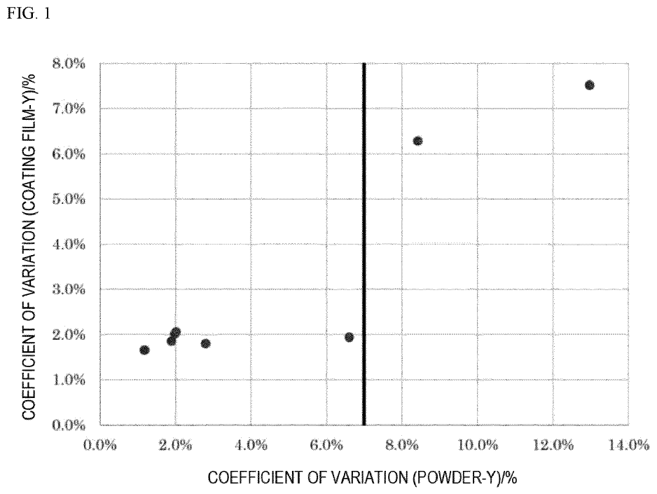

In one aspect of the present invention, the coefficient of variation (α) of an average content of the element yttrium [C_{Y}]ₐᵥ(at %) in the powder for thermal spraying is 7.0% or less. If the coefficient of variation (α) of an average content of the element yttrium [C_{Y}]ₐᵥ(at %) in the powder for thermal spraying exceeds 7.0%, the value for the coefficient of variation of an average content of the element yttrium in the coating film to be formed deteriorates markedly. The present inventors have found that at the value 7.0% of the coefficient of variation (α) of an average content of the element yttrium [C_{Y}]ₐᵥ(at %) in the powder for thermal spraying, there is a critical point to determine whether the coefficient of variation of an average content of the element yttrium in the coating film is good or bad, as is apparent from comparison between Examples and Comparative Examples below and FIG. 1 related thereto.

In one embodiment of the present invention, the coefficient of variation (cc) of an average content of the element yttrium [C_{Y}]ₐᵥ(at %) in the powder for thermal spraying is 6.9% or less, 6.8% or less, 6.7% or less, 6.0% or less, 5.0% or less, 4.0% or less, 3.0% or less, 2.8% or less, 2.7% or less, 2.6% or less, 2.5% or less, 2.4% or less, 2.3% or less, 2.2% or less, 2.0% or less, 1.9% or less, 1.8% or less, 1.7% or less, 1.6% or less, 1.5% or less, 1.4% or less, or 1.3% or less.

In one embodiment of the present invention, the coefficient of variation (α) of an average content of the element yttrium [C_{Y}]ₐᵥ(at %) in the powder for thermal spraying is 0.1% or more.

In one embodiment of the present invention, the particle size (D10) of the powder for thermal spraying, with which the cumulative particle volume from the small particle size side is 10% of the total particle volume in the volume-based cumulative particle size distribution in the laser diffraction scattering particle size distribution measurement method (also referred to as “D10” or “particle size (D10)” simply in the present specification), is 6 μm or more, 7 μm or more, 8 μm or more, 9 μm or more, 10 μm or more, 11 μm or more, or 12 μm or more. Since the powder for thermal spraying has such a lower limit, clogging of a powder tube, adhesion thereto, or spitting thereon with the powder for thermal spraying can be efficiently suppressed during the thermal spraying. In one embodiment of the present invention, the particle size (D10) of the powder for thermal spraying is 20 μm or less, 18 μm or less, 16 μm or less, 15 μm or less, 14 μm or less, 13 μm or less, or 12 μm or less. Since the powder for thermal spraying has such an upper limit, it can exert the desired effect of the present invention efficiently, and particularly when the particle size (D10) of the powder for thermal spraying is 14 μm or less, the coefficient of variation (α) can be more efficiently decreased.

In one embodiment of the present invention, the particle size (D50) of the powder for thermal spraying, with which the cumulative particle volume from the small particle size side is 50% of the total particle volume in the volume-based cumulative particle size distribution in the laser diffraction scattering particle size distribution measurement method (also referred to as “D50” or “particle size (D50)” simply in the present specification), is 15 μm or more, 16 μm or more, 17 μm or more, 18 μm or more, 19 μm or more, 20 μm or more, 21 μm or more, 22 μm or more, 23 μm or more, 24 μm or more, or 25 μm or more. Since the powder for thermal spraying has such a lower limit, clogging of a powder tube, adhesion thereto, or spitting thereon with the powder for thermal spraying can be efficiently suppressed during the thermal spraying. In one embodiment of the present invention, the particle size (D50) of the powder for thermal spraying is 32 μm or less, 30 μm or less, 29 μm or less, 28 μm or less, 27 μm or less, 26 μm or less, 25 μm or less, 24 μm or less, 23 μm or less, 22 μm or less, or 21 μm or less. Since the powder for thermal spraying has such an upper limit, it can exert the desired effect of the present invention efficiently, and particularly when the particle size (D50) of the powder for thermal spraying is 27 μm or less, the surface roughness of the thermally sprayed coating film can be decreased.

In one embodiment of the present invention, the particle size (D90) of the powder for thermal spraying, with which the cumulative particle volume from the small particle size side is 90% of the total particle volume in the volume-based cumulative particle size distribution in the laser diffraction scattering particle size distribution measurement method (also referred to as “D90” or “particle size (D90)” simply in the present specification), is 30 μm or more, 31 μm or more, 32 μm or more, 33 μm or more, or 34 μm or more. Since the powder for thermal spraying has such a lower limit, reduction of product yield during the manufacturing process can be suppressed. In one embodiment of the present invention, the particle size (D90) of the powder for thermal spraying is 50 μm or less, 45 μm or less, 40 μm or less, 39 μm or less, 38 μm or less, 37 μm or less, 36 μm or less, 35 μm or less, 34 μm or less, 33 μm or less, or 32 μm or less. Since the powder for thermal spraying has such an upper limit, it can exert the desired effect of the present invention efficiently, and particularly when the particle size (D90) of the powder for thermal spraying is 40 μm or less, 39 μm or less, 37 μm or less, or 35 μm or less, the surface roughness of the thermally sprayed coating film can be decreased.

In one embodiment of the present invention, the particle size (D90) of the powder for thermal spraying to the particle size (D10) of the powder for thermal spraying, (D90/D10), is less than 3.4. According to such an embodiment, the surface roughness of the thermally sprayed coating film can be decreased. In one embodiment of the present invention, D90/D10 of the powder for thermal spraying is 3.3 or less, 3.2 or less, 3.1 or less, 3.0 or less, 2.9 or less, or 2.8 or less. In one embodiment of the present invention, D90/D10 of the powder for thermal spraying is 2.0 or more, 2.1 or more, 2.2 or more, 2.3 or more, 2.4 or more, or 2.5 or more.

### <Method for Manufacturing Powder for Thermal Spraying>

First, a summary of a preferred embodiment of a method for manufacturing a powder for thermal spraying will be described: a slurry is prepared by mixing a raw material powder and a dispersing medium with a mixing machine. Next, using a spray drying apparatus, a granulated powder is made from the slurry. The thus obtained granulated powder is sintered to obtain a sintered body, then it is further crushed and classified, and thereby, a powder for thermal spraying containing a composite oxide formed with yttrium oxide and aluminum oxide is manufactured.

One aspect of the present invention is a method for manufacturing a powder for thermal spraying, including mixing a mixture containing yttrium oxide, aluminum oxide, and a dispersing medium with a mixing machine to obtain a slurry, wherein the method includes mixing the mixture so as to form the powder for thermal spraying of the above aspect or embodiment.

Hereinafter, the present invention will be described with reference to some embodiments.

In one embodiment of the present invention, the particle size (D50) of yttrium oxide as a raw material powder is 0.1 μm or more, 0.2 μm or more, 0.3 μm or more, 0.5 μm or more, 0.8 μm or more, or 1.0 μm or more. In one embodiment of the present invention, the particle size (D50) of yttrium oxide as a raw material powder is 8.0 μm or less, 6.0 μm or less, 3.0 μm or less, 2.0 μm or less, or 1.0 μm or less. In one embodiment of the present invention, the particle size (D50) of aluminum oxide as a raw material powder is 0.1 μm or more, 0.2 μm or more, 0.3 μm or more, 0.5 μm or more, 0.8 μm or more, or 1.0 μm or more. In one embodiment of the present invention, the particle size (D50) of aluminum oxide as a raw material powder is 8.0 μm or less, 6.0 μm or less, 3.0 μm or less, 2.0 μm or less, or 1.0 μm or less.

In one embodiment of the present invention, the amount of yttrium oxide is 50% by mass or more, 52% by mass or more, 54% by mass or more, 56% by mass or more, 60% by mass or more, 65% by mass or more, 70% by mass or more, 75% by mass or more, 80% by mass or more, or 90% by mass or more, based on the total mass of yttrium oxide and aluminum oxide. In one embodiment of the present invention, the amount of yttrium oxide is 90% by mass or less, 80% by mass or less, 75% by mass or less, 70% by mass or less, 65% by mass or less, 60% by mass or less, 50% by mass or less, 30% by mass or less, or 10% by mass or less, based on the total mass of yttrium oxide and aluminum oxide.

In one embodiment of the present invention, the amount of aluminum oxide is 10% by mass or more, 20% by mass or more, 25% by mass or more, 30% by mass or more, 35% by mass or more, 40% by mass or more, 50% by mass or more, 70% by mass or more, or 90% by mass or more, based on the total mass of yttrium oxide and aluminum oxide. In one embodiment of the present invention, the amount of aluminum oxide is 50% by mass or less, 48% by mass or less, 46% by mass or less, 44% by mass or less, 40% by mass or less, 35% by mass or less, 30% by mass or less, 25% by mass or less, 20% by mass or less, or 10% by mass or less, based on the total mass of yttrium oxide and aluminum oxide.

By appropriately adjusting the mixing ratio between yttrium oxide and aluminum oxide, yttrium aluminum garnet (abbreviation YAG), yttrium aluminum perovskite (abbreviation YAP), or an yttrium-aluminum double oxide powder such as yttrium aluminum monoclinic crystal (abbreviation YAM), or a mixture of yttria powder and alumina powder can be formed. YAG, YAM, and YAP can be manufactured by carrying out mixing at mixing ratios of (Y₂O₃: 57.1% by mass, Al₂O₃: 42.9% by mass), (Y₂O₃: 81.6% by mass, Al₂O₃: 18.4% by mass), and YAP (Y₂O₃: 68.9% by mass, Al₂O₃: 31.1% by mass), respectively.

In one embodiment of the present invention, examples of the dispersing media include water and an alcohol (e.g., the number of carbon atoms 1, 2, or 3).

In one embodiment of the present invention, the amount of the dispersing medium (e.g., water) is 20 parts by mass or more, 30 parts by mass or more, 40 parts by mass or more, 50 parts by mass or more, 60 parts by mass or more, or 70 parts by mass or more, based on the total amount 100 parts by mass of the raw material powder. In one embodiment of the present invention, the amount of the dispersing medium is 300 parts by mass or less, 250 parts by mass or less, 200 parts by mass or less, 150 parts by mass or less, 80 parts by mass or less, 70 parts by mass or less, 60 parts by mass or less, 50 parts by mass or less, 40 parts by mass or less, or 30 parts by mass or less, based on the total amount 100 parts by mass of the raw material powder.

In one embodiment of the present invention, to yttrium oxide, aluminum oxide, and the dispersing medium (e.g., water or a composition containing an alcohol or the like), one or more additives selected from a binder (e.g., polyvinyl butyral resin (PVB), polyvinyl alcohol resin (PVA)-polyvinyl acetate resin-polyacrylic resin) and a pH adjusting agent (e.g., an acid, such as acetic acid, citric acid, oxalic acid, or hydrochloric acid, or an alkali, such as ammonia, sodium hydroxide, or potassium hydroxide) may be further added. The additive amount of the additives can be an amount not inhibiting the desired effect of the present invention.

In one aspect of the present invention, the mixture containing yttrium oxide, aluminum oxide, and the dispersing medium is mixed so as to finally form a powder for thermal spraying of the above aspect or embodiment.

In one embodiment of the present invention, the mixture is mixed using a medium. In one embodiment of the present invention, the mixing machine to mix the mixture (i) has a storage part that stores a medium therein and an agitating blade that rotates in the storage part and agitates the mixture together with the medium. In one embodiment of the present invention, the mixing machine to mix the mixture (ii) has a storage part that stores a medium therein, the storage part rotating and thereby making it possible to agitate the mixture together with the medium.

In one embodiment of the present invention, a mixing time for the mixture is an enough time to form a powder for thermal spraying of the above aspect. A specific mixing time for the mixture can vary depending on the amount of the raw material powder fed into the mixing machine, the specification of the mixing machine, etc., and there is a possibility that the specific mixing time cannot be defined unconditionally, but in one embodiment of the present invention, the specific mixing time is, for example, 30 seconds or more, 40 seconds or more, 50 seconds or more, 1 minute or more, 3 minutes or more, 7 minutes or more, 10 minutes or more, 12 minutes or more, 15 minutes or more, 25 minutes or more, 45 minutes or more, 1 hour or more, or 1 hour and a half or more. In one embodiment of the present invention, the specific mixing time for the mixture is, for example, 10 hours or less, 8 hours or less, 6 hours or less, 4 hours or less, 3 hours or less, 1 hour and a half or less, 50 minutes or less, 40 minutes or less, 30 minutes or less, less than 30 minutes, 25 minutes or less, 15 minutes or less, 12 minutes or less, 7 minutes or less, 3 minutes or less, or 2 minutes or less. In one embodiment of the present invention, the mixing time for the mixture is more than 10 minutes and less than 30 minutes.

In one embodiment of the present invention, an agitation rate of the agitation part (e.g., agitating blade) in the mixing machine is an enough rate to form a powder for thermal spraying of the above aspect. A specific agitation rate of the agitation part in the mixing machine can vary depending on the amount of the raw material powder fed into the mixing machine, the specification of the mixing machine, etc., and there is a possibility that the specific agitation rate cannot be defined unconditionally, but in one embodiment of the present invention, the specific agitation rate is, for example, 50 rpm or more, 70 rpm or more, 90 rpm or more, 110 rpm or more, 130 rpm or more, 150 rpm or more, or 170 rpm or more. In one embodiment of the present invention, there is a possibility that the specific agitation rate of the agitation part (e.g., agitating blade) in the mixing machine cannot be defined unconditionally, similarly to the above, but the specific agitation rate is 1000 rpm or less, 800 rpm or less, 600 rpm or less, 400 rpm or less, 300 rpm or less, 250 rpm or less, 200 rpm or less, or 170 rpm or less.

In one embodiment of the present invention, when the agitation rate of the agitation part (e.g., agitating blade) in the mixing machine is less than 190 rpm, the mixing time for the mixture is less than 5 minutes.

In one embodiment of the present invention, when the agitation rate of the agitation part (e.g., agitating blade) in the mixing machine is more than 150 rpm, the mixing time for the mixture is more than 5 minutes and less than 30 minutes, or more than 10 minutes and less than 30 minutes.

In one embodiment of the present invention, when the mixing machine is that of a type not having an agitation part (e.g., agitating blade) and having a rotational storage part, there is a possibility that the rotational rate of the storage part cannot be defined unconditionally, similarly to the above, but the rotational rate is 50 rpm or more, 70 rpm or more, 90 rpm or more, 110 rpm or more, 130 rpm or more, 150 rpm or more, or 170 rpm or more. In one embodiment of the present invention, there is a possibility that the rotational rate of the storage part cannot be defined unconditionally, similarly to the above, but the rotational rate is 1000 rpm or less, 800 rpm or less, 600 rpm or less, 400 rpm or less, or 300 rpm or less.

As described above, in one aspect of the present invention, the mixture containing yttrium oxide, aluminum oxide, and a dispersing medium is mixed so as to form a powder for thermal spraying of the above aspect or embodiment. In order to do that, it is preferable to set the conditions and the like in accordance with the guidelines described in the embodiment of the present disclosure. In that case, if necessary, a sample of a powder for thermal spraying is prepared from a part of a slurry obtained by mixing the mixture with a mixing machine, and whether the sample is a powder for thermal spraying of the above aspect or embodiment or not is confirmed (in particular, whether the coefficient of variation (α) of an average content of the element yttrium [C_{Y}]ₐᵥ(at %) in the powder for thermal spraying is 7.0% or less or not is confirmed). If the sample is a powder for thermal spraying of the above aspect or embodiment, a powder for thermal spraying can be prepared also from the remaining slurry. If the sample is not a powder for thermal spraying of the above aspect or embodiment, mixing of the remaining slurry can be adjusted. Adjustment of the mixing can include adjustment of the mixing time for the mixture, the agitation rate of the agitation part, or the rotational rate of the storage part. By doing this, a novel powder for thermal spraying capable of more certainly improving performance of an yttrium-aluminum composite oxide coating film can be provided.

In one embodiment of the present invention, the total amount of the medium used for the mixing is 200 parts by mass or more, 400 parts by mass or more, 500 parts by mass or more, or 600 parts by mass or more, based on the total amount 100 parts by mass of the raw material powder.

In one embodiment of the present invention, the total amount of the medium used for the mixing is 1000 parts by mass or less, 900 parts by mass or less, 800 parts by mass or less, 700 parts by mass or less, 300 parts by mass or less, 150 parts by mass or less, 100 parts by mass or less, or 50 parts by mass or less, based on the total amount 100 parts by mass of the raw material powder. In one embodiment of the present invention, the average particle size of the medium used for the mixing can be, for example, 0.5 to 10 mm, or 0.8 to 8 mm. In one embodiment of the present invention, the material of the medium is preferably zirconium oxide, aluminum oxide, or the like. In one embodiment of the present invention, the shape of the medium can be a spherical shape. The concept of the spherical shape includes not only a true sphere but also an ellipsoid and the like. The particle size of a sphere that is not a true sphere is measured as the longest diameter (diameter). The average particle size can also be determined by arithmetically averaging diameters of any plurality (e.g., 10, 50, or 100) of media.

In one embodiment of the present invention, a granulated powder is prepared by carrying out granulation together with drying the slurry using a spray drying apparatus.

In one embodiment of the present invention, the granulated powder is sintered to prepare a sintered body. In one embodiment of the present invention, the sintering temperature of the granulated powder can be 1000° C. or more, 1400° C. or more, 1500° C. or more, or 1600° C. or more.

In one embodiment of the present invention, the sintering temperature of the granulated powder can be 1900° C. or less. In one embodiment of the present invention, the sintering time for the granulated powder can be 1 hour or more, 2 hours or more, 4 hours or more, 5 hours or more, 6 hours or more, or 12 hours or more. In one embodiment of the present invention, the sintering time for the granulated powder is usually 24 hours or less, without limiting thereto.

In one embodiment of the present invention, crushing and classification of the sintered body obtained by sintering can be carried out so as to satisfy at least one of the above-described D10, D50, D90, and D90/D10 of the powder for thermal spraying. By doing this, the coefficient of variation (α) can efficiently become 7.0% or less, and consequently, appearance of heterogenous phases in a composite oxide coating film formed with yttrium oxide and aluminum oxide can be significantly suppressed. In addition, the presence of yttrium in the coating film can be made more homogeneous. Furthermore, the surface roughness of the coating film can also be decreased. The sieve used for the classification is preferably, for example, a vibrating sieve. The opening (JISZ8801-1:2019 nominal opening) of the sieve is, for example, 32 to 90 μm, 38 to 75 μm, or 45 to 63 μm.

In one embodiment of the present invention, when the coating film is subjected to component analysis at any plurality (n) of positions of a scanning electron microscope image (SEM image) by an energy dispersive X-ray spectrometer (EDX) in which characteristic X-ray peak areas are measured, and a content of the element yttrium (C_{Y}(at %)) and a content of the element aluminum (C_{Al}(at %)) are calculated from a ratio of the peak areas and determined so as to satisfy the relationship of the following expression (1):

$$\begin{matrix}[ Expression 5 ] & \\ {C}_{Y} + {C}_{A 1} = 100 ( at \% ) , & ( 1 )\end{matrix}$$

and wherein a coefficient of variation (α) of an average content of the element yttrium [C_{Y}]ₐᵥ(at %) calculated by dividing a total value by n, the total value being obtained by adding a content of the element yttrium [C_{Y}] at each position represented by the following expression (2):

$$\begin{matrix}[ Expression 6 ] & \\ {C}_{Y} / ( {C}_{Y} + {C}_{A 1} ) ( at \% ) , & ( 2 )\end{matrix}$$

is 6.0% or less, 5.0% or less, 4.0% or less, 3.0% or less, 2.5% or less, 2.2% or less, 2.0% or less, 1.9% or less, or 1.8% or less. In one embodiment of the present invention, the coefficient of variation of an average content of the element yttrium [C_{Y}]ₐᵥ(at %) in the coating film is 0.1% or more. In one aspect of the present invention, n represents the number of arbitrarily selected positions to obtain a scanning electron microscope image (SEM image), and the number can be 10 (n=10). Citing the present embodiment as an example, the values for the contents of the element yttrium [C_{Y}] at the 10 positions are all added, then the value obtained thereby is divided by 10 to obtain an average content of the element yttrium [C_{Y}]ₐᵥ(at %) calculated, and a coefficient of variation (α) indicating a degree of variation from the average content [C_{Y}]ₐᵥ(at %) is calculated.

In one embodiment of the present invention, the surface roughness (arithmetic average roughness) Ra of the coating film is 7.5 μm or less, 7.0 μm or less, 6.5 μm or less, 6.0 μm or less, 5.5 μm or less, 5.3 μm or less, 5.1 μm or less, 5.0 μm or less, or 4.9 μm or less. In one embodiment of the present invention, the surface roughness Ra of the coating film is 1.0 μm or more, or 1.5 μm or more.

Although the embodiments of the present invention have been described in detail, these are illustrative and exemplary but not restrictive, and it is apparent that the scope of the present invention should be interpreted by the scope of claims attached.

The present invention includes the following aspects and embodiments.
1. A powder for thermal spraying, comprising a composite oxide formed with yttrium oxide and aluminum oxide, wherein the powder for thermal spraying is subjected to component analysis at any plurality (n) of positions of a scanning electron microscope image (SEM image) by an energy dispersive X-ray spectrometer (EDX) in which characteristic X-ray peak areas are measured, and a content of the element yttrium (C_{Y}(at %)) and a content of the element aluminum (C_{Al}(at %)) are calculated from a ratio of the peak areas and determined so as to satisfy the relationship of the following expression (1):

$$\begin{matrix}[ Expression 7 ] & \\ {C}_{Y} + {C}_{A 1} = 100 ( at \% ) , & ( 1 )\end{matrix}$$

and wherein a coefficient of variation (α) of an average content of the element yttrium [C_{Y}]ₐᵥ(at %) calculated by dividing a total value by n, the total value being obtained by adding a content of the element yttrium [C_{Y}] at each position represented by the following expression (2):

$$\begin{matrix}[ Expression 8 ] & \\ {C}_{Y} / ( {C}_{Y} + {C}_{A 1} ) ( at \% ) , & ( 2 )\end{matrix}$$

is 7.0% or less.
2. The powder for thermal spraying according to 1., wherein the particle size (D90) with which the cumulative particle volume from the small particle size side is 90% of the total particle volume in the volume-based cumulative particle size distribution in the laser diffraction scattering particle size distribution measurement method to the particle size (D10) with which the cumulative particle volume from the small particle size side is 10% of the total particle volume in the volume-based cumulative particle size distribution in the laser diffraction scattering particle size distribution measurement method, (D90/D10), is less than 3.4.
3. The powder for thermal spraying according to 1, or 2., wherein the particle size (D90) with which the cumulative particle volume from the small particle size side is 90% of the total particle volume in the volume-based cumulative particle size distribution in the laser diffraction scattering particle size distribution measurement method is 40 μm or less.
4. A method for manufacturing a powder for thermal spraying, comprising mixing a mixture containing yttrium oxide, aluminum oxide, and a dispersing medium with a mixing machine to obtain a slurry, wherein the method comprises mixing the mixture so as to form the powder for thermal spraying according to any one of 1. to 3.
5. The method according to 4., wherein the mixing machine (i) has a storage part that stores a medium therein and an agitating blade that rotates in the storage part to agitate the mixture together with the medium, or (ii) has a storage part that stores a medium therein, the storage part rotating and thereby agitating the mixture together with the medium.
6. The method according to 4, or 5., comprising preparing a sample of a powder for thermal spraying from a part of the slurry and confirming whether the sample meets the requirement according to any one of 1. to 4., and comprising preparing a powder for thermal spraying also from the remaining slurry if the sample meets the requirement, or adjusting mixing of the remaining slurry if the sample does not meet the requirement.

In addition, as one aspect of the present invention, provided is a method for manufacturing a powder for thermal spraying, comprising mixing a mixture containing yttrium oxide, aluminum oxide, and a dispersing medium with a mixing machine to obtain a slurry, wherein the mixing machine (i) has a storage part that stores a medium therein and an agitating blade that rotates in the storage part to agitate the mixture together with the medium, or (ii) has a storage part that stores a medium therein, the storage part rotating and thereby agitating the mixture together with the medium.

In one embodiment of the present invention, the method is preferably set in such a manner that the powder for thermal spraying is subjected to component analysis at any plurality (n) of positions of a scanning electron microscope image (SEM image) by an energy dispersive X-ray spectrometer (EDX) in which characteristic X-ray peak areas are measured, and a content of the element yttrium (C_{Y}(at %)) and a content of the element aluminum (C_{Al}(at %)) are calculated from a ratio of the peak areas and determined so as to satisfy the relationship of the following expression (1):

$$\begin{matrix}[ Expression 9 ] & \\ {C}_{Y} + {C}_{A 1} = 100 ( at \% ) , & ( 1 )\end{matrix}$$

and wherein a coefficient of variation (α) of an average content of the element yttrium [C_{Y}]ₐᵥ(at %) calculated by dividing a total value by n, the total value being obtained by adding a content of the element yttrium [C_{Y}] at each position represented by the following expression (2):

$$\begin{matrix}[ Expression 10 ] & \\ {C}_{Y} / ( {C}_{Y} + {C}_{A 1} ) ( at \% ) , & ( 2 )\end{matrix}$$

is 7.0% or less. The descriptions made above can be applied to the descriptions of this embodiment.

### EXAMPLES

The present invention will be described in more detail using the following examples and comparative examples. However, the technical scope of the present invention is not restricted to only the following examples.

### Example 1

### (Manufacture of Powder for Thermal Spraying (Granules))

Materials including 0.5 kg of a raw material powder formed with Y₂O₃ powder (D50: 1.0 m) and Al₂O₃ powder (D50: 0.5 μm) and 0.5 kg of water were prepared. The materials were fed into a mixing machine A having a storge part in which a medium (average particle size: 5 mm) made of zirconium oxide of 3.0 kg (600 parts by mass based on 100 parts by mass of the whole raw material powder) in total had been stored, and a bar-like arm (agitating blade) capable of rotating in the storage part and agitating a mixture formed with the above materials together with the medium.

The agitation rate of the agitating blade was set to 150 rpm, and mixing of the mixture was carried out for 1 minute to prepare a slurry. The mixing proportions of the Y₂O₃ powder and the Al₂O₃ powder were set to 57.1% by mass and 42.9% by mass, respectively, in the total mass of the whole raw material powder (Y₂O₃ powder and Al₂O₃ powder).

Thereafter, the slurry was subjected to drying and granulation using a spray drying apparatus (spray dryer) to prepare a granulated powder.

Thereafter, the granulated powder was subjected to solid phase sintering at a sintering temperature of 1600° C. for a sintering time of 6 hours to obtain a sintered body.

Thereafter, the sintered body was crushed and subsequently classified by using a vibrating sieve having an opening (JISZ8801-1:2019 nominal opening) of 53 μm to obtain a powder for thermal spraying (granules) having a particle size distribution described in Table 1.

### (Preparation of Thermally Sprayed Coating Film)

Using the powder for thermal spraying, a thermally sprayed coating film was prepared by APS (atmospheric plasma spraying). In the present example, as a base material, a plate material (70 mm×50 mm×2.3 mm) made of an aluminum alloy (Al6061), the surface of which had been subjected to surface roughening by carrying out blasting using a brown alumina abrasive material (A #40), was used. In the present example, into plasma generated in a thermal spraying machine, the powder for thermal spraying was fed, and while moving a thermal spraying gun at a rate of 400 mm/sec, a thermally sprayed coating film was prepared by setting the plasma irradiation angle to the base material to 90 degrees. The spraying distance was set to 120 mm. The “spraying distance” relating to the preparation of a thermally sprayed coating film refers to a distance from the tip of the thermal spraying gun to the base material.

### [Conditions]

Base material: aluminum alloy (Al6061) (70 mm×50 mm×2.3 mm)
Thermal spraying machine: SG-100 (manufactured by Praxair Surface Technologies Inc.)
Powder feeder: Model 1264 (manufactured by Praxair Surface Technologies Inc.)

### Plasma Working Gas:

Ar gas pressure: 50 psi (0.34 MPa)
He gas pressure: 50 psi (0.34 MPa)
Plasma output: 36 kW
Voltage: 40 V
Current: 900 A
Rate: 400 mm/sec
Spraying distance: 120 mm
Plasma irradiation angle: 90 degrees
feed rate of powder for thermal spraying: 20 g/min.

### Examples 2 to 5

Each powder for thermal spraying (granules) was obtained and each coating film was formed in the same manner as in Example 1, except for changing the time and the agitation rate to those shown in Table 1.

### Example 6

A powder for thermal spraying (granules) was obtained and a coating film was formed in the same manner as in Example 1, except that the materials were fed into a mixing machine B having a storage part in which a medium (average particle size: 1 mm) of 3.0 kg (600 parts by mass based on 100 parts by mass of the whole raw material powder) in total had been stored, the storage part being capable of rotating and thereby agitating a mixture together with the medium, then the agitation (rotational) rate of the storage part (pot) was set to 150 rpm, and mixing of the mixture was carried out for 120 minutes to prepare a slurry.

### Comparative Example 1

Materials prepared in the same manner as in Example 1 were fed into a high-speed disperser C having no medium and equipped with an agitating blade.

The agitation rate of the agitating blade was set to 5000 rpm, and mixing of the mixture was carried out for 30 minutes to prepare a slurry.

Thereafter, by carrying out operations in the same manner as in Example 1, except for performing classification using a vibrating sieve having an opening of 75 μm, a powder for thermal spraying (granules) having a particle size distribution described in Table 1 was obtained and a coating film was formed.

### Comparative Example 2

A powder for thermal spraying (granules) was obtained and a coating film was formed in the same manner as in Example 1, except for performing classification using a vibrating sieve having an opening of 53 μm.

### <Measurement Method>

### (Volume-Based Cumulative Particle Size Distribution>

As described above, D10, D50, and D90 mean particle sizes with which the cumulative particle volumes from the small particle size side are 10%, 50%, and 90%, respectively, of the total particle volume in the volume-based cumulative particle size distribution. D10, D50, and D90 can be measured by the laser diffraction scattering method. In the section of [EXAMPLES], the volume-based particle size distribution was measured by using a laser diffraction particle size distribution measuring device (manufactured by Malvern Panalytical Ltd., Mastersizer 3000).

### (Evaluation Procedure for Coefficient of Variation of Powder for Thermal Spraying)

A base resin (model: 1551) of a two-pack curable epoxy resin (epoxy resin manufactured by HERZOG JAPAN CO., LTD.), a curing agent (model: 1552-2), and a powder for thermal spraying were sufficiently mixed (two-pack curable resin total mass: powder for thermal spraying manufactured in each example or each comparative example=6:4).

To a bottom surface of a plastic ring (manufactured by BUEHLER Ltd., 208151100 [1 in]), a tape was allowed to adhere in such a manner that the adhesive surface faced inside the ring in order to prevent leakage of the resin, and then the plastic ring was filled with the obtained mixture before the mixture was cured.

After the two-pack resin was cured, the adhesive tape was peeled off from the plastic ring, and the observation surface (lower side of the ring) was subjected to polishing to expose the cross section of the powder, thereby preparing a sample for evaluation of a powder for thermal spraying capable of being subjected to SEM observation and component analysis by EDS.

Using a scanning electron microscope (SEM) and an energy dispersive X-ray spectrometer (EDX) (Phenom ProX manufactured by Phenom-World Holding B.V.) attached to the device, component analysis in a region of 5000 magnifications (size of a field of view of 53.7 μm square (53.7 μm×53.7 μm)) at any plurality (n=10) of positions randomly selected on each sample for evaluation was carried out, and a content of the element yttrium (C_{Y}(at %)) and a content of the element aluminum (C_{Al}(at %)) were calculated from a ratio of characteristic X-ray peak areas and determined so as to satisfy the relationship of the following expression (1):

$$\begin{matrix}[ Expression 11 ] & \\ {C}_{Y} + {C}_{A 1} = 100 ( at \% ) , & ( 1 )\end{matrix}$$

and a content of the element yttrium [C_{Y}] at each position represented by the following expression (2):

$$\begin{matrix}[ Expression 12 ] & \\ {C}_{Y} / ( {C}_{Y} + {C}_{A 1} ) ( at \% ) & ( 2 )\end{matrix}$$

was added. The acceleration voltage in the energy dispersive X-ray spectrometer (EDX) was set to 15 kV.

The value obtained by the addition was divided by 10 to calculate an average content of the element yttrium [C_{Y}]ₐᵥ(at %), and a standard deviation was determined, and thereafter, it was divided by the average content of the element yttrium to calculate each coefficient of variation. The results are set forth in Table 1.

By the way, measurement of a coefficient of variation of the powder for thermal spraying was carried out using a sample also containing a two-pack curable epoxy resin, but it is added that because an Y atom and an Al atom were not contained in the two-pack curable epoxy resin, there was no influence on the numerical value for the coefficient of variation. The same applies to the measurement of a coefficient of variation of the coating film. The size of a field of view of SEM in the measurement of a coefficient of variation of the powder for thermal spraying may be 53.7 μm±3 μm square.

### (Evaluation Procedure for Coefficient of Variation of Thermally Sprayed Coating Film)

The thermally sprayed coating film prepared in each of examples and comparative examples was cut to a size of 20 mm×10 mm×2.3 mm using a cutter so that the coating film cut could be placed in a plastic ring (manufactured by BUEHLER Ltd., 208151100 [1 in]).

To a bottom surface of the plastic ring, a tape was allowed to adhere in such a manner that the adhesive surface faced inside the ring, and then adhesion-fixed so that the cross section of the thus cut thermally sprayed coating film might be positioned at the lower side (adhesive surface of the adhesive tape).

Thereafter, the two-pack curable epoxy resin obtained by previously mixing the base resin and the curing agent sufficiently was poured.

After the two-pack resin was cured, the adhesive tape was peeled off from the plastic ring, and the observation surface (lower side of the ring) was subjected to polishing to expose the cross section of the coating film, thereby preparing a sample for evaluation of a thermally sprayed coating film capable of being subjected to SEM observation and component analysis by EDS.

A coefficient of variation of an average content of the element yttrium in the coating film was calculated in the same manner as in the method for determining the coefficient of variation of an average content of the element yttrium in the powder for thermal spraying, except for changing the size of the component analysis region of each sample for evaluation to 15000 magnifications (size of a field of view of 17.9 μm square (17.9 μm×17.9 μm)). The acceleration voltage in the energy dispersive X-ray spectrometer (EDX) was set to 15 kV. The results are set forth in Table 1.

The size of a field of view of SEM in the measurement of evaluation of a coefficient of variation of the thermally sprayed coating film may be 17.9 μm±3 μm square.

### (Surface Roughness Ra of Coating Film)

The surface roughness Ra of the coating film was measured in accordance with JIS B0601:2013. For determining the surface roughness Ra, a surface roughness at each of any 5 positions on each of the coating films was measured using a surface roughness measuring instrument (manufactured by Mitutoyo Corporation, SV-3000S CNC), and an arithmetic mean value of these was obtained as the surface roughness Ra.

TABLE 1

| | | | | | | | | | | | Coating |
|---|---|---|---|---|---|---|---|---|---|---|---|
| | | | | | | | | | Coefficient of | | film |
| | Mixing method | | | | Particle size | | | | variation | | Average |
| | | | | Agitation/ | distribution | | | | | Coating | surface |
| | Mixing | Medium | Time | Rotational | D10 | D50 | D90 | D90/ | Granules- | film- | roughness |
| No. | machine | (mm) | (min.) | rate (rpm) | (μm) | (μm) | (μm) | D10 | Y (%) | Y (%) | (μm) |
| Comparative | C | — | 30 | 5000 | 17.1 | 33.1 | 58.0 | 3.4 | 13.0% | 7.5% | 8.0 |
| Example 1 | | | | | | | | | | | |
| Comparative | C | — | 30 | 5000 | 14.5 | 24.3 | 39.4 | 2.7 | 8.4% | 6.3% | 5.2 |
| Example 2 | | | | | | | | | | | |
| Example 1 | A | 5 | 1 | 150 | 12.9 | 21.3 | 34.5 | 2.7 | 6.6% | 1.9% | 4.8 |
| Example 2 | A | 5 | 5 | 190 | 13.5 | 22.0 | 35.1 | 2.6 | 2.8% | 1.8% | 5.2 |
| Example 3 | A | 5 | 10 | 190 | 13.6 | 22.0 | 34.9 | 2.6 | 2.0% | 2.0% | 5.0 |
| Example 4 | A | 5 | 20 | 190 | 12.4 | 19.6 | 30.7 | 2.5 | 2.0% | 2.1% | 4.8 |
| Example 5 | A | 5 | 30 | 190 | 13.9 | 27.2 | 47.0 | 3.4 | 1.9% | 1.9% | 6.4 |
| Example 6 | B | 1 | 120 | 190 | 11.3 | 21.5 | 37.1 | 3.3 | 1.2% | 1.7% | 5.2 |

This application is based on Japanese Patent Application No. 2023-054593 filed on Mar. 30, 2023, the whole contents of the disclosure of which are hereby incorporated by reference.

1. A powder for thermal spraying, comprising a composite oxide formed with yttrium oxide and aluminum oxide, wherein
the powder for thermal spraying is subjected to component analysis at any plurality (n) of positions of a scanning electron microscope image (SEM image) by an energy dispersive X-ray spectrometer (EDX) in which characteristic X-ray peak areas are measured, and a content of the element yttrium (C_{Y}(at %)) and a content of the element aluminum (C_{Al}(at %)) are calculated from a ratio of the peak areas and determined so as to satisfy a relationship of the following expression (1):
$$\begin{matrix}[ Expression 1 ] & \\ {C}_{Y} + {C}_{A 1} = 100 ( at \% ) , & ( 1 )\end{matrix}$$
and wherein a coefficient of variation (α) of an average content of the element yttrium [C_{Y}]ₐᵥ(at %) calculated by dividing a total value by n, the total value being obtained by adding a content of the element yttrium [C_{Y}] at each position represented by the following expression (2):
$$\begin{matrix}[ Expression 2 ] & \\ {C}_{Y} / ( {C}_{Y} + {C}_{A 1} ) ( at \% ) , & ( 2 )\end{matrix}$$
is 7.0% or less.

2. The powder for thermal spraying according to claim 1, wherein the particle size (D90) with which the cumulative particle volume from the small particle size side is 90% of the total particle volume in the volume-based cumulative particle size distribution in the laser diffraction scattering particle size distribution measurement method to the particle size (D10) with which the cumulative particle volume from the small particle size side is 10% of the total particle volume in the volume-based cumulative particle size distribution in the laser diffraction scattering particle size distribution measurement method, (D90/D10), is less than 3.4.

3. The powder for thermal spraying according to claim 1, wherein the particle size (D90) with which the cumulative particle volume from the small particle size side is 90% of the total particle volume in the volume-based cumulative particle size distribution in the laser diffraction scattering particle size distribution measurement method is 40 μm or less.

4. A method for manufacturing a powder for thermal spraying, comprising mixing a mixture comprising yttrium oxide, aluminum oxide, and a dispersing medium with a mixing machine to obtain a slurry, wherein
the method comprises mixing the mixture so as to form the powder for thermal spraying according to claim 1.

5. The method according to claim 4, wherein the mixing machine
(i) has a storage part that stores a medium therein and an agitating blade that rotates in the storage part to agitate the mixture together with the medium, or
(ii) has a storage part that stores a medium therein, the storage part rotating and thereby agitating the mixture together with the medium.

6. (canceled)

7. A method for manufacturing a powder for thermal spraying, comprising:
mixing a mixture comprising yttrium oxide, aluminum oxide, and a dispersing medium with a mixing machine to obtain a slurry,
preparing a sample of a powder for thermal spraying from a part of the slurry and confirming whether the sample meets a requirement (A), and
preparing a powder for thermal spraying also from the remaining slurry if the sample meets the requirement (A), or adjusting mixing of the remaining slurry if the sample does not meet the requirement (A),
wherein the mixing machine (i) has a storage part that stores a medium therein and an agitating blade that rotates in the storage part to agitate the mixture together with the medium, or (ii) has a storage part that stores a medium therein, the storage part rotating and thereby agitating the mixture together with the medium, and
wherein the requirement (A) is:
the powder for thermal spraying, when subjected to component analysis at any plurality (n) of positions of a scanning electron microscope image (SEM image) by an energy dispersive X-ray spectrometer (EDX) in which characteristic X-ray peak areas are measured, and a content of the element yttrium (C_{Y}(at %)) and a content of the element aluminum (C_{Al}(at %)) are calculated from a ratio of the peak areas and determined so as to satisfy a relationship of the following expression (1):
$$\begin{matrix}[ Expression 1 ] & \\ {C}_{Y} + {C}_{A 1} = 100 ( at \% ) , & ( 1 )\end{matrix}$$
and a coefficient of variation (α) of an average content of the element yttrium [C_{Y}]ₐᵥ(at %) calculated by dividing a total value by n, the total value being obtained by adding a content of the element yttrium [C_{Y}] at each position represented by the following expression (2):
$$\begin{matrix}[ Expression 2 ] & \\ {C}_{Y} / ( C + {C}_{A 1} ) ( at \% ) , & ( 2 )\end{matrix}$$
is 7.0% or less.
